(19) United States
(12) Patent Application Publication
(10) Pub. No.: US 2018/0107877 A1
(43) Pub. Date: Apr. 19, 2018

(54) IMAGE PROCESSING APPARATUS, IMAGE PROCESSING METHOD, AND IMAGE PROCESSING SYSTEM

(71) Applicant: CANON IMAGING SYSTEMS INC., Niigata-shi, Niigata (JP)

(72) Inventor: Yasushi INABA, Niigata-shi (JP)

(21) Appl. No.: 15/562,014

(22) PCT Filed: Mar. 18, 2016
(86) PCT No.: PCT/JP2016/059785

§ 371 Date: Sep. 27, 2017

(30) Foreign Application Priority Data
Apr. 1, 2015 (JP) 2015-075185

(51) Int. Cl. G06K 9/00; G06T 7/00

(52) U.S. Cl. CPC G06K 9/00677; G06K 9/00248; G06T 7/97; G06T 2207/30232; G06T 2207/30196; G06T 2207/30221; G06K 2209/01

(57) ABSTRACT

An image processing method for a picture of a participant, photographed in an event, such as a marathon race, increases the accuracy of recognition of a race bib number by performing image processing on a detected race bib area, and associates the recognized race bib number with a person in the picture. This image processing method detects a person from an input image, estimates an area in which a race bib exists based on a face position of the detected person, detects an area including a race bib number from the estimated area, performs image processing on the detected area to thereby perform character recognition of the race bib number from an image subjected to the image processing, and associates, when the race bib number is unclear, an object and the race bib number with each other by comparing images between a plurality of input images.

### TECHNICAL FIELD

The present invention relates to an image processing method for a picture photographed in an event, such as a marathon race.

### BACKGROUND ART

There has been known an image ordering system in which images of persons, such as visitors and event participants, are photographed by a camera in a theme park, an event site, and so forth, and are registered in a database, whereby visitors, event participants, and the like can select and buy desired person images by searching the database.

In such an image ordering system, to enhance the recognition accuracy of a race bib number of an event participant based on a person image, the present applicant has proposed an image processing apparatus that detects a person from an input image, estimates an area in which a race bib exists based on a face position of the detected person, and detects an area including a race bib number from the estimated area to thereby perform image processing on the detected area, recognize characters on the race bib number from the image subjected to image processing, and associate the result of character recognition with the input image (see PTL 1).

### CITATION LIST

### Patent Literature

PTL 1: Specification of Japanese Patent Application No. 2014-259258

### SUMMARY OF INVENTION

### Technical Problem

The present invention provides an image processing apparatus enhanced and evolved from the image processing apparatus proposed in PTL 1 by the present applicant and processing a large amount of photographed images, which, even when a race bib number is unclear, associates an object and the race bib number by performing image comparison between a plurality of input images.

### Solution to Problem

To solve the above-described problems, the image processing apparatus as claimed in claim 1 is an image processing apparatus that repeatedly processes a plurality of input images as a target image, sequentially or in parallel, comprising an image sorting section that determines a processing order of the plurality of input images based on photographing environment information, an identification information recognition section that performs recognition processing of identification information for identifying an object existing in the target image according to the processing order determined by the image sorting section, and associates a result of the recognition processing and the target image with each other, a chronologically-ordered image comparison section that compares, in a case where an object which is not associated with the identification information exists in the target image processed by the identification information recognition section, a degree of similarity between the target image and reference images which are sequentially positioned chronologically before or after the target image in the processing order, and an identification information association section that associates identification information associated with one of the reference images with the target image based on a result of comparison by the chronologically-ordered image comparison section.

### Advantageous Effects of Invention

According to the present invention, it is possible to associate an object in an input image and a race bib number at high speed by using a degree of similarity of objects or feature values between a plurality of input images.

### BRIEF DESCRIPTION OF DRAWINGS

FIG. 1 A block diagram of an example of an image processing apparatus 100 according to a first embodiment of the present invention.

FIG. 2A A flowchart useful in explaining the whole process performed by the image processing apparatus 100 shown in FIG. 1, for processing photographed images.

FIG. 2B A flowchart useful in explaining a process performed by the image processing apparatus 100 shown in FIG. 1, for associating a race bib number and a person image with each other based on face feature values of an object.

FIG. 2C A flowchart useful in explaining the process performed by the image processing apparatus 100 shown in FIG. 1, for associating the race bib number and the person image with each other based on the face feature values of the object.

FIG. 3 A diagram useful in explaining the process performed by the image processing apparatus 100, for associating the race bib number and the person image with each other based on the face feature values of the object.

FIG. 4 A block diagram of an example of an image processing apparatus 200 according to a second embodiment of the present invention.

FIG. 5A A flowchart useful in explaining a process performed by the image processing apparatus 200, for associating a race bib number and a person image with each other based on a relative positional relationship between persons.

FIG. 5B A flowchart useful in explaining the process performed by the image processing apparatus 200, for associating the race bib number and the person image with each other based on the relative positional relationship between the persons.

FIG. 6 A diagram useful in explaining the process performed by the image processing apparatus 200, for associating the race bib number and the person image with each other based on the relative positional relationship between the persons.

FIG. 7 A block diagram of an example of an image processing apparatus 300 according to a third embodiment of the present invention.

FIG. 8A A flowchart useful in explaining a process performed by the image processing apparatus 300, for associating a race bib number and a person image with each other based on image information, composition feature values, and image feature values.

FIG. 8B A flowchart useful in explaining a process performed by the image processing apparatus 300, for associating the race bib number and the person image with each other based on the image information, the composition feature values, and the image feature values.

FIG. 9 Examples of images used in the process performed by the image processing apparatus 300, for associating the race bib number and the person image with each other based on the image information and the image feature values.

FIG. 10 A block diagram of an example of an image processing apparatus 400 according to a fourth embodiment of the present invention.

FIG. 11 A flowchart useful in explaining a process performed by the image processing apparatus 400, for associating a race bib number and a person image with each other based on information of a race bib number on preceding and following images.

FIG. 12 Examples of images used in the process performed by the image processing apparatus 400, for associating the race bib number and the person image with each other based on the information of the race bib number on the preceding and following images.

### DESCRIPTION OF EMBODIMENTS

The present invention will now be described in detail below with reference to the drawings showing embodiments thereof.

### First Embodiment

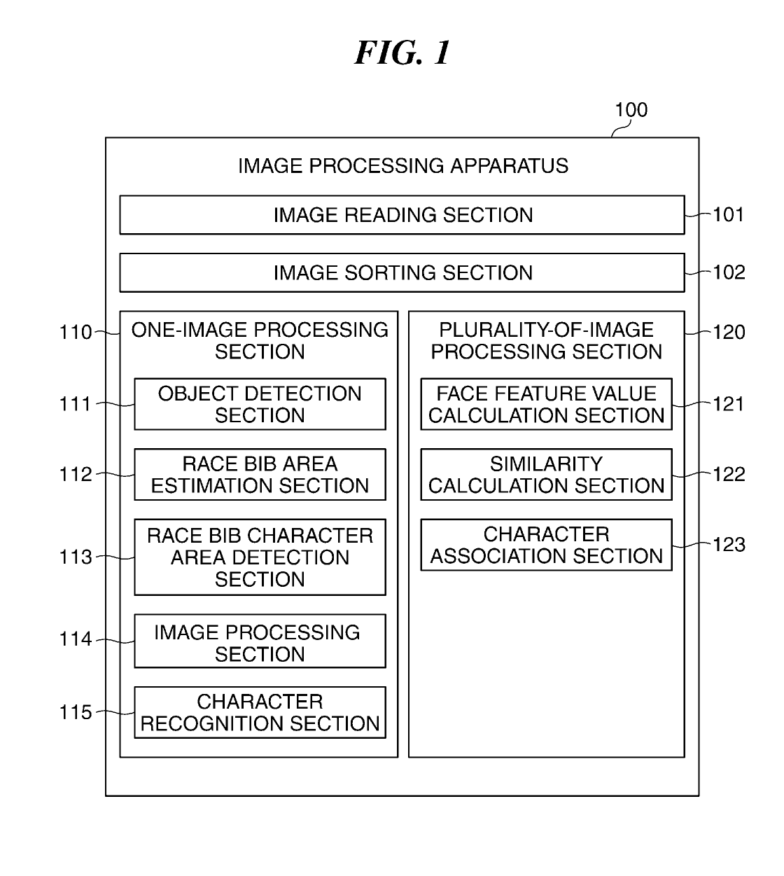

FIG. 1 is a block diagram of an example of an image processing apparatus 100 according to a first embodiment of the present invention.

### <Configuration of Image Processing Apparatus 100>

The illustrated image processing apparatus 100 is an apparatus, such as a personal computer (PC). The image processing apparatus 100 may be an apparatus, such as a mobile phone, a PDA, a smartphone, and a tablet terminal.

The image processing apparatus 100 includes a CPU, a memory, a communication section, and a storage section (none of which are shown) as the hardware configuration.

The CPU controls the overall operation of the image processing apparatus 100. The memory is a RAM, a ROM, and the like.

The communication section is an interface for connecting to e.g. a LAN, a wireless communication channel, and a serial interface, and is a function section for receiving a photographed image from an image pickup apparatus.

The storage section stores, as software, an operating system (hereinafter referred to as the OS: not shown), an image reading section 101, an image sorting section 102, a one-image processing section 110, a plurality-of-image processing section 120, and software associated with other functions. Note that these software items are read into the memory, and operate under the control of the CPU.

Hereafter, the function of each function section will be described in detail.

The image reading section 101 reads a photographed image, a display rendering image, and so on, from the memory, as an input image, and loads the read image into the memory of the image processing apparatus 100. More specifically, the image reading section 101 decompresses a compressed image file, such as a JPEG file, converts the image file to a raster image in an array of RGB values on a pixel-by-pixel, and loads the raster image into the memory of the PC. At this time, in a case where the number of pixels of the read input image is not large enough, pixel interpolation may be performed to thereby increase the number of pixels to a sufficiently large number so as to maintain a sufficient accuracy for detection of an object by an object detection section 111, and recognition by an image processing section 114 and a character recognition section 115. Further, in a case where the number of pixels is larger than necessary, the number of pixels may be reduced by thinning the pixels so as to increase the speed of processing. Further, to correct a width and height relation of an input image, the input image may be rotated as required.

The image sorting section 102 sorts input images loaded into the memory of the image processing apparatus 100 in a predetermined order. For example, the image sorting section 102 acquires an update time and a creation time of each input image, or an image photographing time recorded in the input image, and sorts the input images in chronological order. Here, the file format of the input image is e.g. JPEG, and if the number of input images is enormous, such as several tens of thousands, it takes a lot of time to sort the images, and hence a unit number of images to be sorted may be changed such that the input images are divided into units of several tens of images.

The one-image processing section 110 includes the object detection section 111, a race bib area estimation section 112, a race bib character area detection section 113, the image processing section 114, and the character recognition section 115, and is a function section for processing input images one by one (sequentially or in parallel) in an order in which the input images are sorted by the image sorting section 102. For example, the one-image processing section 110 processes the input images which are arranged in a chronological ascending or descending order.

The object detection section 111 detects respective object areas existing within input images. A method of detecting an object includes, e.g. in a case of an object being a person, a method of detection based on features of a face of a person and features of organs, such as a mouth and eyes, a method of detection based on features of a shape of a head, and a method of detection based on a hue of a skin area or the like of a person, but is not limited to these, and a combination of a plurality of detection methods may be used. Hereafter, the description is given assuming that the object is a person.

The race bib area estimation section 112 estimates, based on the position of a face and the size of a shoulder width, from a person area detected in the input image by the object detection section 111, that a race bib character area exists in a torso in a downward direction from the face. Note that the object of which the existence is to be estimated is not limited to the race bib, but may be a uniform number, or identification information directly written on part of an object. Further, the estimation is not to be performed limitedly in the downward direction, but the direction can be changed according to a posture of a person or composition of an input image, on an as-needed basis.

The race bib character area detection section 113 detects an area which can be characters with respect to each area estimated by the race bib area estimation section 112. Here, the characters refer to an identifier which makes it possible to uniquely identify an object, such as numbers, alphabets, hiragana, katakana, Chinese characters, numbers and symbols, and a pattern of barcode.

The image processing section 114 performs image processing with respect to each area detected by the race bib character area detection section 113 as pre-processing for character recognition.

The character recognition section 115 recognizes characters with respect to the input image processed by the image processing section 114 based on a dictionary database (not shown) in which image features of candidate characters are described, and associates the recognition result with a person image. The person image refers to part of an input image in which a person exists.

The plurality-of-image processing section 120 includes a face feature value calculation section 121, a similarity calculation section 122, and a character association section 123, and is a function section for processing a target input image based on the result of processing by the one-image processing section 110 by referring to input images temporally before and after the target input image.

The face feature value calculation section 121 calculates a face feature value based on organs, such as eyes and a mouth, with respect to an object in each input image, from which a face of a person is detected by the object detection section 111.

The similarity calculation section 122 calculates a degree of similarity by comparing the face feature value of each person between the input images.

If a person who is not associated with characters exists in the target input image, the character association section 123 detects an object estimated to be most probably the corresponding person from another input image based on the similarity calculated by the similarity calculation section 122, and associates the characters associated with the corresponding person with the person in the target input image.

### <Processing Flow of Image Processing Apparatus 100>

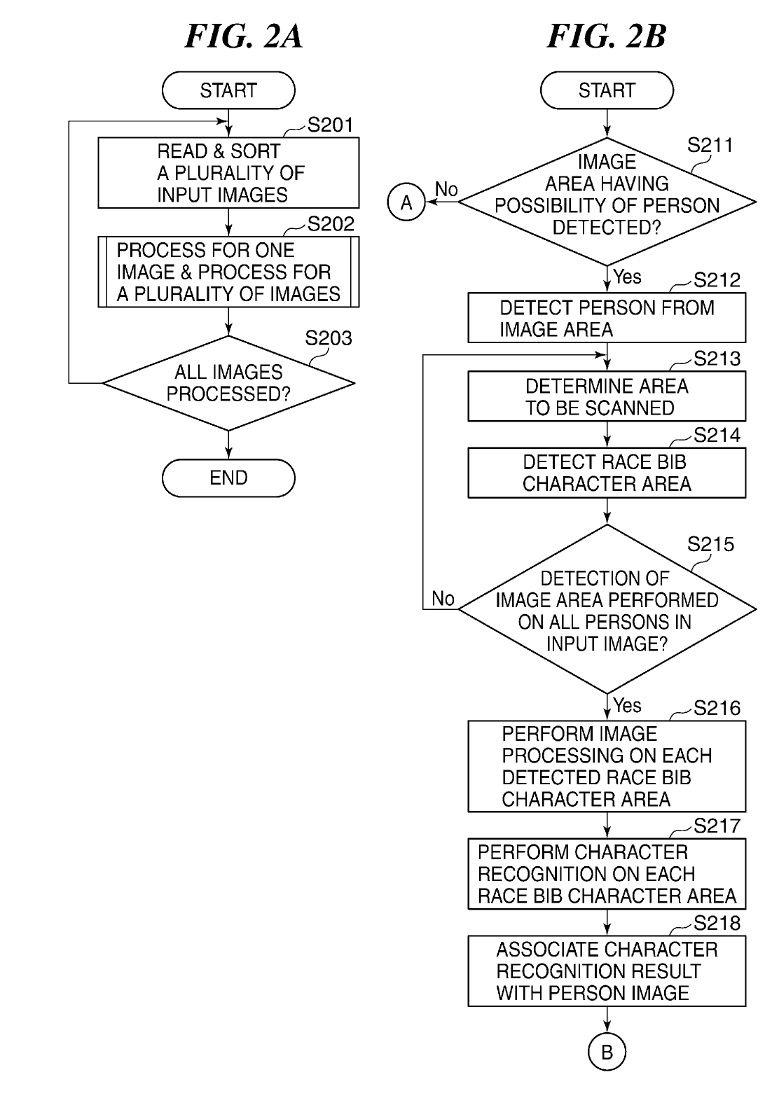

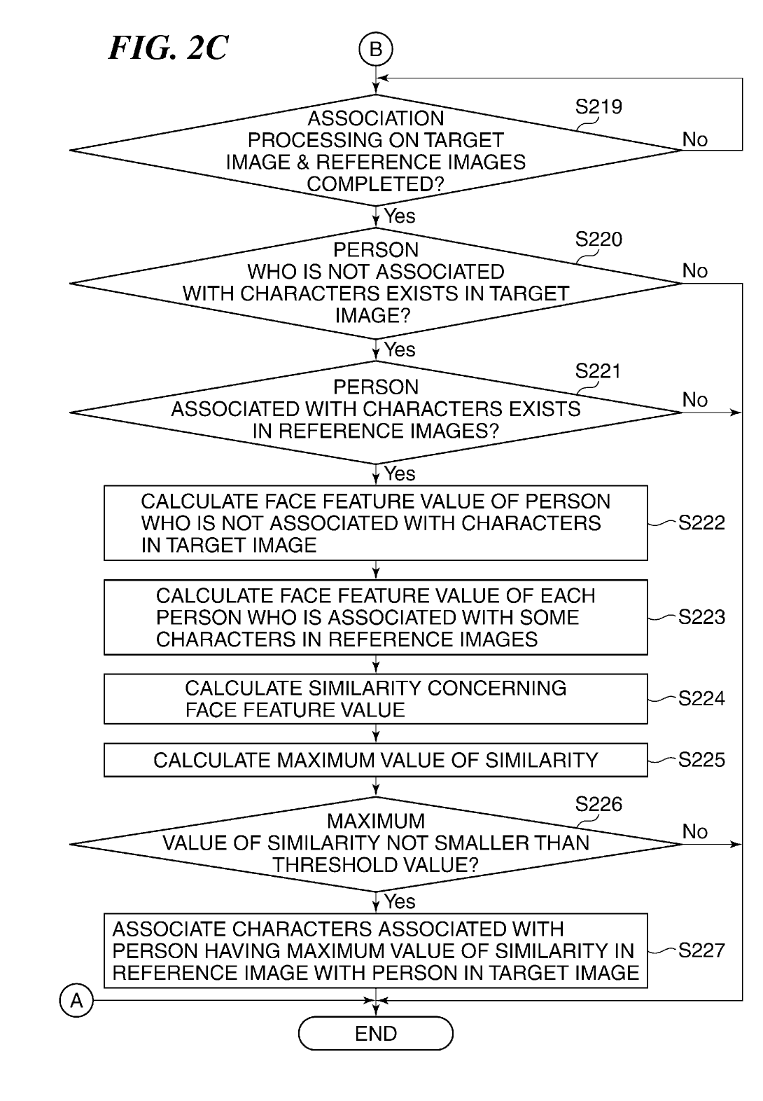

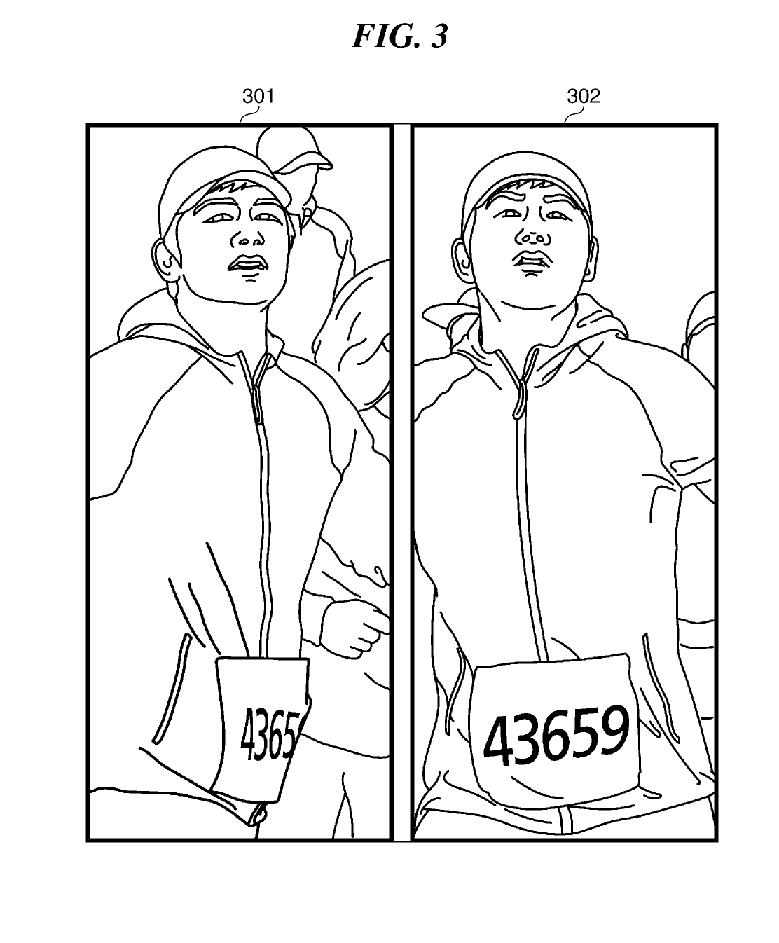

FIG. 2A is a flowchart useful in explaining the whole process performed by the image processing apparatus 100 shown in FIG. 1, for processing photographed images. FIGS. 2B and 2C are a flowchart useful in explaining a process performed by the image processing apparatus 100 shown in FIG. 1, for associating a race bib number and a person image with each other based on face feature values of an object.

In the following description, a target input image is referred to as the target image, and a n-number of temporally sequential input images each before and after the target image, which are made sequential to the target image by sorting, are referred to as the reference images. Note that the n-number of each of the preceding input images and the following input images may be changed according to a situation of an event or a photographing interval of the photographed images or the like. Further, the n-number can be changed, based on the photographing time recorded in each input image (e.g. JPEG image), according to a condition that the input images are images photographed within a certain time period. In addition, the reference images are not necessarily reference images before and after the target image, but may be only reference images before the target image or only reference images after the target image, or there may be no reference image before and after the target image.

First, the whole process performed for photographed images will be described with reference to the flowchart in FIG. 2A.

The image reading section 101 reads (2n+1) images consisting of a target image and the n-number of images each before and after the target image, as input images, whereby the process is started, and the image sorting section 102 sorts the read (2n+1) images as the temporally sequential images based e.g. on the photographing times (step S201). This is because sorting of the images increases the possibility of a case where a target person is found in the other input images which are chronologically before and after the target image, when face authentication is performed.

The one-image processing section 110 and the plurality-of-image processing section 120 perform the process in FIGS. 2B and 2C, described hereinafter, with respect to the (2n+1) images read as the input images, sequentially or in parallel (step S202).

Then, the plurality-of-image processing section 120 determines whether or not the process is completed with respect to all of the photographed images (step S203). If the process is completed with respect to all of the photographed images (Yes to the step S203), the processing flow is terminated. If the process is not completed with respect to all of the photographed images (No to the step S203), the process returns to the step S201, wherein the image reading section 101 reads (2n+1) images as the next input images.

Next, the step S202 in FIG. 2A will be described with reference to the flowchart in FIGS. 2B and 2C.

Steps S211 to S218 in FIG. 2B are executed by the one-image processing section 110, and steps S219 to S227 in FIG. 2C are executed by the plurality-of-image processing section 120.

First, the object detection section 111 scans the whole raster image of the read target image, and determines whether or not there is an image area having a possibility of a person (step S211).

If there is an image area having a possibility of a person (Yes to the step S211), the process proceeds to the step S212. If there is no image area having a possibility of a person (No to the step S211), the processing flow is terminated.

The object detection section 111 detects a person from the image area having the possibility of a person in the target image (step S212).

The race bib area estimation section 112 estimates that a race bib character area is included in each person area detected by the object detection section 111, and determines an area to be scanned (step S213). The area to be scanned is determined based on a size in the vertical direction of the input image and a width of the person area, and is set to an area in the downward direction from the face of the person. In the present example, the size in the vertical direction and the width of the area to be scanned may be changed according to the detection method used by the object detection section 111.

The race bib character area detection section 113 detects a race bib character area from the area to be scanned, which is determined for each person (step S214). As a candidate of the race bib character area, the race bib character area detection section 113 detects an image area which can be expected to be a race bib number, such as numerals and characters, and detects an image area including one or a plurality of characters. Here, although the expression of the race bib number is used, the race bib number is not limited to numbers.

The race bib character area detection section 113 determines whether or not detection of an image area has been performed with respect to all persons in the target image (step S215), and if there is a person on which the detection has not been performed yet (No to the step S215), the process returns to the step S213 so as to perform race bib character area detection with respect to all persons.

When race bib character area detection with respect to all persons in the target image is completed (Yes to the step S215), the image processing section 114 performs image processing on each detected race bib character area as pre-processing for performing character recognition (step S216). Here, the image processing refers to deformation correction, inclination correction, depth correction, and so forth. Details of the image processing are described in the specification of Japanese Patent Application No. 2014-259258, which was filed earlier by the present applicant.

After the image processing on all of the detected race bib character areas is completed, the character recognition section 115 performs character recognition with respect to each race bib character area (step S217).

The character recognition section 115 associates a result of character recognition with the person image (step S218).

When character recognition with respect to all race bib character areas is completed, the process on one input image (here, the target image) is terminated.

Similarly, the processing operations for detecting a person and performing character recognition in the steps S211 to S218 are performed also with respect to the n-number of reference images each before and after the target image, whereby it is possible to obtain the results of characters associated with a person image.

The plurality-of-image processing section 120 determines whether or not the association processing based on the result of character recognition is completed with respect to the reference images, similarly to the target image (step S219). If the association processing is completed with respect to the target image and the reference images, the process proceeds to the step S220, whereas if not, the process returns to the step S219, whereby the plurality-of-image processing section 120 waits until the association processing is completed with respect to the (2n+1) images of the target image and the reference images.

The character recognition section 115 detects whether or not a person who is not associated with characters exists in the target image (step S220). If appropriate characters are associated with all of persons in the target image (No to the step S220), the processing flow is terminated.

If a person who is not associated with any characters exists in the target image (Yes to the step S220), the character recognition section 115 detects whether or not a person who is associated with any characters exists in the n-number of reference images each before and after the target image (step S221).

If a person who is associated with any characters exists in the reference images (Yes to the step S221), the face feature value calculation section 121 calculates a feature value of a face of the person who is not associated with any characters in the target image (step S222). If there is no person who is associated with any characters in the reference images, (No to the step S221), the processing flow is terminated.

Next, the face feature value calculation section 121 calculates a feature value of a face of each detected person who is associated with any characters in the reference images (step S223).

The similarity calculation section 122 calculates a degree of similarity between the face feature value of the person who is not associated with characters in the target image and the face feature value of each detected person who is associated with any characters in the reference images (step S224). The similarity is standardized using a value of 100 as a reference, and as the similarity is higher, this indicates that the feature values of the respective faces are very close to each other, and there is a high possibility that the persons are the same person.

Here, the feature value calculated based on organs of a face tends to depend on the orientation of the face. If a person in the target image is oriented to the right, it is assumed that the feature value is affected by the orientation of the face to the right. To more accurately calculate a degree of similarity in this case, the degree of similarity may be calculated such that only persons oriented to the right are extracted from the reference images, whereby the face feature value calculation section 121 calculates a feature value of each extracted person, and the similarity calculation section 122 compares the feature value between the person in the target image and each person extracted from the reference images to calculate the degree of similarity therebetween.

Then, the similarity calculation section 122 calculates the maximum value of the degree of similarity out of the degrees of similarity calculated in the step S224 (step S225).

The similarity calculation section 122 determines whether or not the maximum value of the degree of similarity is not smaller than a threshold value determined in advance (step S226). If the maximum value of the degree of similarity is not smaller than the threshold value (Yes to the step S226), the character association section 123 associates the characters associated with a person having the maximum value of the face feature value in the reference images with the person who is not associated with characters in the target image (step S227). If the maximum value of the degree of similarity is smaller than the threshold value (No to the step S226), the processing flow is terminated.

Here, the threshold value of the degree of similarity may be a fixed value calculated e.g. by machine learning. Further, the threshold value may be changed for each orientation of a face. Further, the threshold value can be dynamically changed according to a resolution, a state, or the like of a target image.

FIG. 3 shows an example of input images, and the process performed by the image processing apparatus 100, for associating a race bib number and a person image with each other based on feature values of a face, will be described with reference to FIG. 3.

An image 301 and an image 302 are images obtained by photographing the same person, and are input images temporally sequential when sorted by the image sorting section 102. The steps of the processing flow described with reference to FIGS. 2B and 2C will be described using these images 301 and 302.

In the image 301, although the face is oriented in a front direction, the torso is oriented in a lateral direction, and part of a race bib number is hidden, and hence all of the race bib number cannot be correctly recognized by the character recognition section 115. It is assumed that as a result of execution of the steps S211 to S218, it is known that although image processing and number recognition are performed by the image processing section 114 and the character recognition section 115, the number cannot be correctly recognized.

Further, in the image 302, the face is similarly oriented in the front direction, and it is assumed that as a result of execution of the steps S211 to S218, it is known that the whole race bib number can be correctly recognized by the character recognition section 115.

In the step S219, the plurality-of-image processing section 120 judges that the association processing with respect to the image 301 and the image 302 is completed, and the process proceeds to the step S220.

In the step S220, although the character recognition section 115 has detected a person from the image 301, characters are not associated with the person, and hence in the step S221, the character recognition section 115 determines whether or not a person who is associated with characters is included in the sequential image 302.

In the step S222, the face feature value calculation section 121 calculates a feature value of the face of the person in the image 301. Next, in the step S223, the face feature value calculation section 121 calculates a feature value of the face of the person in the image 302.

In the step S224, the similarity calculation section 122 calculates a degree of similarity between the face feature values calculated in the steps S222 and S223.

In the step S225, the similarity calculation section 122 calculates the maximum value of the degree of similarity. In the step S226, the similarity calculation section 122 compares the maximum value of the degree of similarity with the threshold value, and in the step S227, since the maximum value of the degree of similarity is not smaller than the threshold value, the character association section 123 associates the characters of the image 302 with the person in the image 301.

As described above, according to the first embodiment of the present invention, in a case where it is impossible to correctly recognize characters on a race bib in an input image, the feature value of a face of a person in another input image which is temporally sequential to the input image is used, whereby it is possible to associate a character string in the other input image with the race bib in the input image.

### Second Embodiment

Next, a description will be given of a second embodiment of the present invention.

### <Configuration of Image Processing Apparatus 200>

In the first embodiment, organs of a face are detected, face feature values are calculated, and it is required to satisfy a condition that in the target image and the reference images, the faces of persons are oriented in the same direction, and characters on a race bib in the reference image are correctly recognized.

However, in the images photographed in an actual event, there often occurs a case where the characters of all digits on a race bib cannot be correctly recognized, such as a case where a race bib and an arm of a person are overlapped with each other due to his/her running form. The second embodiment interpolates the first embodiment in a case where the first embodiment cannot be applied, and is characterized in that a target person is estimated based on a relative positional relationship with a person or a reference object in another input image, and a character string of the other input image is associated with the target person.

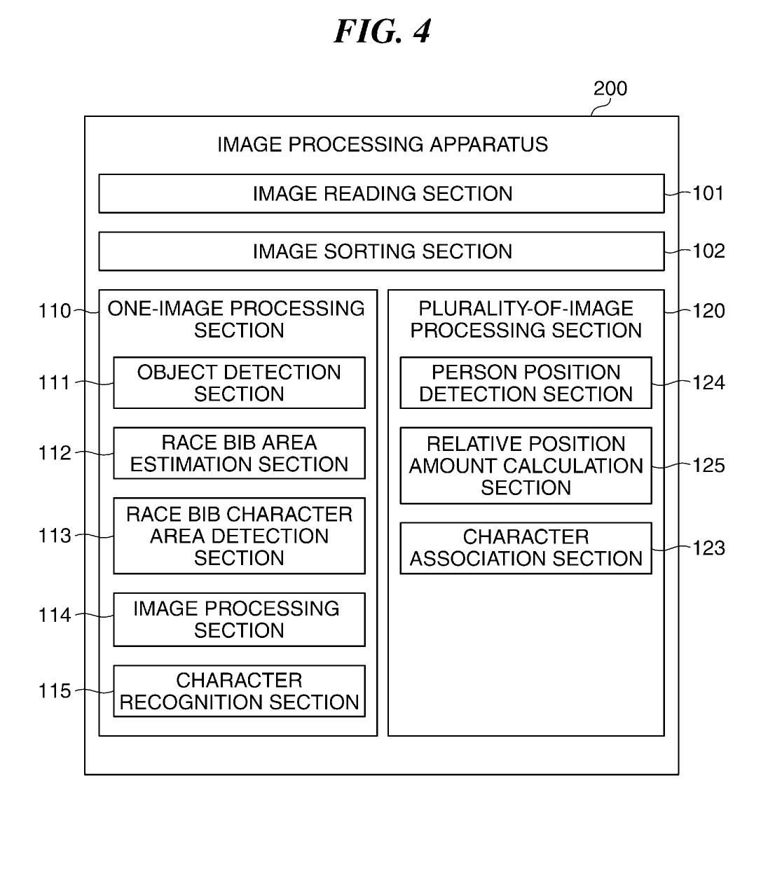

FIG. 4 is a block diagram of an example of an image processing apparatus 200 according to the second embodiment.

The present embodiment has the same configuration as that of the image processing apparatus 100 described in the first embodiment, in respect ranging from the image reading section 101 to the character recognition section 115. The present embodiment differs from the first embodiment in a person position detection section 124 and a relative position amount calculation section 125 of the plurality-of-image processing section 120. Note that the same component elements as those of the image processing apparatus 100 shown in FIG. 1 are denoted by the same reference numerals, and description thereof is omitted.

The person position detection section 124 calculates, with respect to a person detected by the object detection section 111, the position of the person in the input image.

The relative position amount calculation section 125 calculates an amount of movement of the relative position of a person to the position of a reference object between the plurality of input images. Here, the reference object refers to a person moving beside a target person, or a still object, such as a guardrail and a building along the street, which makes it possible to estimate the relative position of the target person. The reference object is not limited to this, but any other object can be used, insofar as it makes it possible to estimate the relative position of the target person.

If it is determined by the relative position amount calculation section 125 that the relative positions of persons to the reference object are equal to each other, the character association section 123 associates the characters of a corresponding person in the reference image with a person in the target image.

### <Processing Flow of Image Processing Apparatus 200>

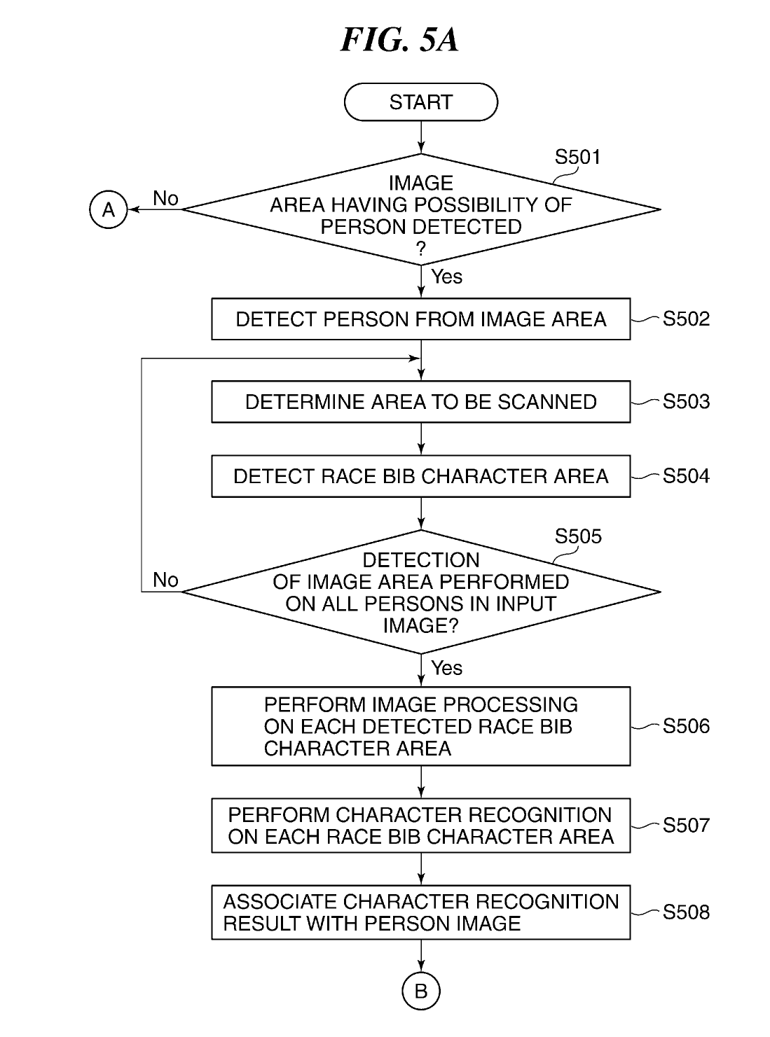

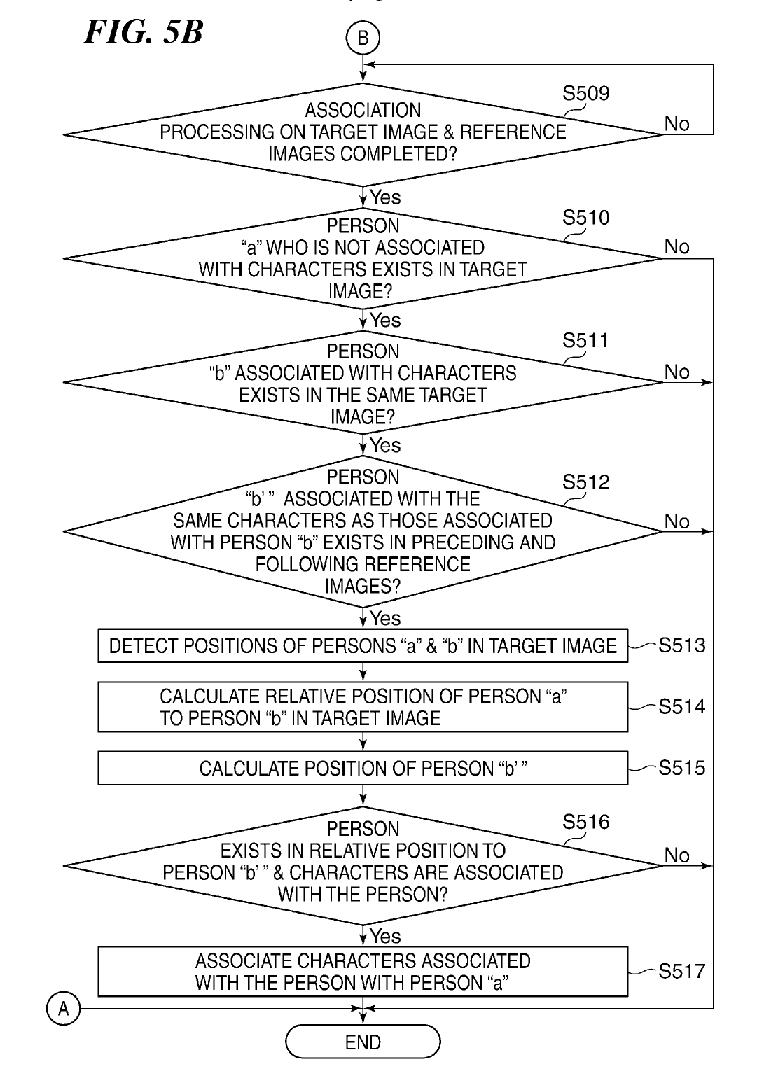

FIG. 5 is a flowchart useful in explaining a process performed by the image processing apparatus 200 shown in FIG. 4, for associating a race bib number and a person image with each other based on a relative positional relationship between persons.

In the following description, similar to the first embodiment, a target input image is referred to as the target image, and a n-number of temporally sequential input images each before and after the target image, which are made sequential to the target image by sorting, are referred to as the reference images.

The whole process performed for photographed images is the same as the steps S201 to S203 described with reference to FIG. 2A in the first embodiment. Details of the step S202 in the present embodiment, which is executed by the one-image processing section 110 and the plurality-of-image processing section 120 with respect to (2n+1) images read as input images, sequentially or in parallel, will be described with reference to FIG. 5.

Steps S501 to S508 in FIG. 5A are executed by the one-image processing section 110, and steps S509 to S517 in FIG. 5B are executed by the plurality-of-image processing section 120.

The steps S501 to S508 are the same as the steps S211 to S218 described with reference to the flowchart in FIG. 2B in the first embodiment.

The object detection section 111 scans the whole raster image of the read target image, and determines whether or not there is an image area having a possibility of a person (step S501).

If there is an image area having the possibility of one or more persons in the target image (Yes to the step S501), the process proceeds to a step S502. If there is no image area having the possibility of a person in the target image (No to the step S501), the processing flow is terminated.

The object detection section 111 detects a person from the image area having the possibility of a person (step S502).

The race bib area estimation section 112 estimates that a race bib character area is included in each person area detected by the object detection section 111, and determines an area to be scanned (step S503). The area to be scanned is determined based on a size in the vertical direction of the input image and a width of the person area, and is set to an area in the downward direction from the face of the person. In the present example, the size in the vertical direction and the width of the area to be scanned may be changed according to the detection method used by the object detection section 111.

The race bib character area detection section 113 detects a race bib character area from the area to be scanned, which is determined for each person (step S504). As a candidate of the race bib character area, the race bib character area detection section 113 detects an image area which can be expected to be a race bib number, such as numerals and characters, and detects an image area including one or a plurality of characters.

The race bib character area detection section 113 determines whether or not detection of an image area has been performed with respect to all persons in the target image (step S505), and if there is a person on which the detection has not been performed yet (No to the step S505), the process returns to the step S503 so as to perform race bib character area detection with respect to all persons.

When race bib character area detection with respect to all persons is completed (Yes to the step S505), the image processing section 114 performs image processing on each detected race bib character area as pre-processing for performing character recognition (step S506).

After the image processing on all of the detected race bib character areas is completed performed, the character recognition section 115 performs character recognition with respect to each race bib character area (step S507).

The character recognition section 115 associates a result of character recognition with the person image (step S508).

When character recognition with respect to all race bib character areas is completed, the process for processing one input image (target image in this process) is terminated.

Similarly, the processing operations for detecting a person and performing character recognition in the steps S501 to S508 are performed also with respect to the n-number of reference images each before and after the target image, whereby it is possible to obtain the results of characters associated with a person image.

The plurality-of-image processing section 120 determines whether or not the association processing based on the result of character recognition is completed with respect to the reference images, similarly to the target image (step S509). If the association processing is completed with respect to the target image and the reference images, the process proceeds to the step S510, whereas if not, the process returns to the step S509, whereby the plurality-of-image processing section 120 waits until the association processing is completed with respect to the (2n+1) images of the target image and the reference images.

The character recognition section 115 detects whether or not a person who is not associated with characters exists in the target image (step S510). If appropriate characters are associated with all of persons in the target image (No to the step S510), the processing flow is terminated.

If a person “a” who is not associated with any characters exists (Yes to the step S510), the character recognition section 115 searches the same target image for a person “b” who is associated with any characters (step S511). If there is no person who is associated with some characters (No to the step S511), the processing flow is terminated.

If there is the person “b” who is associated with any characters (Yes to the step S511), the character recognition section 115 searches the n-number of reference images each before and after the target image for a person “b′” who is associated with the same characters as those associated with the person b (step S512).

If there is the person “b′” who is associated with the same characters as those associated with the person “b” (Yes to the step S512), the person position detection section 124 detects the respective positions of the person “a” and the person “b” in the target image (step S513). If there is no person “b′” who is associated with the same characters as those associated with the person b (No to the step S512), the processing flow is terminated.

Further, the relative position amount calculation section 125 calculates a relative position based on the positions of the person “a” and the person “b” in the target image (step S514).

Then, the person position detection section 124 detects the position of the person “b′” in the n-number of reference images each before and after the target image (step S515).

The relative position amount calculation section 125 determines whether or not a person exists in a relative position to the person “b′” in the reference image, corresponding to the relative position of the person “a” to the person “b” in the target image, which is calculated in the step S514, and there are characters associated with the person (step S516).

If there are characters associated with the person (Yes to the step S516), the character association section 123 associates the characters associated with the person with the person “a” in the target image (step S517). If there are no characters associated with the person (No to the step S516), the processing flow is terminated.

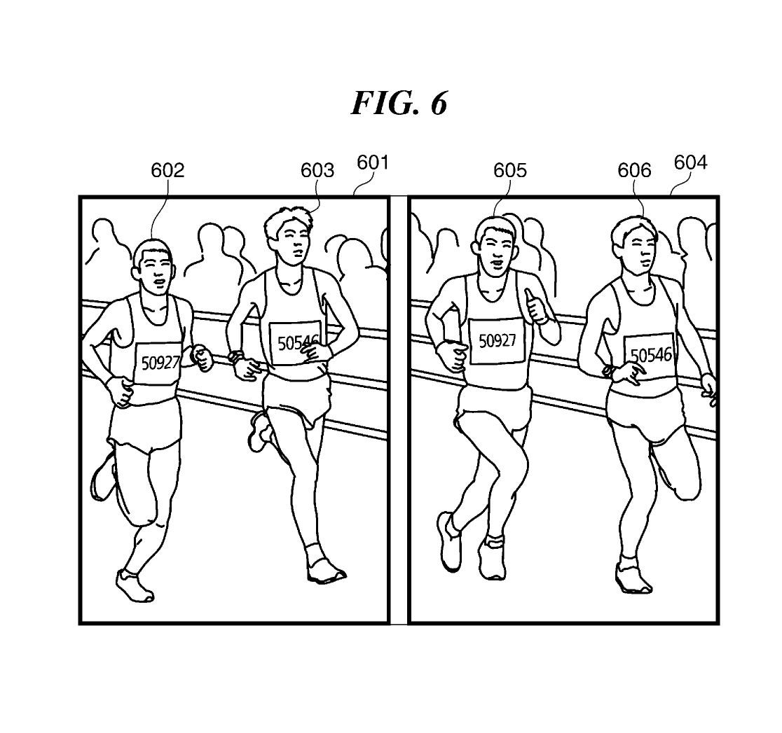

FIG. 6 shows an example of input images, and the process performed by the image processing apparatus 200, for associating a race bib number and a person image with each other based on a relative positional relationship between persons, will be described with reference to FIG. 6.

An image 601 and an image 604 are images formed by photographing the same two persons running beside each other, and are temporally sequential input images when sorted by the image sorting section 102. The steps of the processing flow described with reference to FIGS. 5A and 5B will be described using these images 601 and 604.

In the image 601, a person 602 and a person 603 are photographed. It is assumed that as a result of execution of the steps S501 to S508, it is known that although all of the characters on the race bib of the person 602 are recognized by the character recognition section 115, part of the race bib of the person 603 is hidden by his hand, and hence all of the characters cannot be correctly recognized.

Further, in the image 604 temporally sequential to the image 601, a person 605 and a person 606 are photographed, and it is assumed that as a result of execution of the steps S501 to S508, it is known that the characters on the race bibs of the two persons (persons 605 and 606) can be recognized by the character recognition section 115.

In the step S509, the plurality-of-image processing section 120 judges that the association processing is completed with respect to the image 601 and the image 604, and the process proceeds to the step S510.

In the step S510, the person 603 corresponds to the person “a” who is not associated with characters, in the image 601.

In the step S511, the person 602 corresponds to the person “b” who is associated with characters, in the image 601.

In the step S512, the person 605 is detected, in the image 604, as the person “b′” who is associated with the same characters as those associated with the person “b”.

In the step S513, the person position detection section 124 detects the positions of the persons 602 and the person 603.

In the step S514, the relative position amount calculation section 125 calculates the relative position of the person 603 to the person 602.

In the step S515, the person position detection section 124 detects the position of the person 605.

In the step S516, the relative position amount calculation section 125 detects the person 606 based on the relative position to the person 605.

In the step S517, the character association section 123 associates the characters on the race bib of the person 606 with the person 603.

Here, although as the reference object existing in the relative position to the person 603, the person 602 running beside the person 603 is selected, the reference object may be a still object, such as a guardrail and a building along the street, which makes it possible to estimate a relative position.

As described above, according to the second embodiment of the present invention, in a case where it is impossible to correctly recognize a race bib in an input image, a relative positional relationship with a person or a reference object in another input image which is temporally sequential to the input image is used, whereby it is possible to perform association of the characters in the other input image.

### Third Embodiment

### <Configuration of Image Processing Apparatus 300>

Next, a description will be given of a third embodiment of the present invention.

The first and second embodiments use the method of searching input images for a person, and associating characters associated with the detected person with a person in a target image.

The third embodiment is characterized in that person areas are extracted from input images by excluding background images from the input images, and feature values of the person areas are compared, whereby the processing speed is increased by not transferring characters associated with a person to a person, but transferring characters associated with a reference image to a target image.

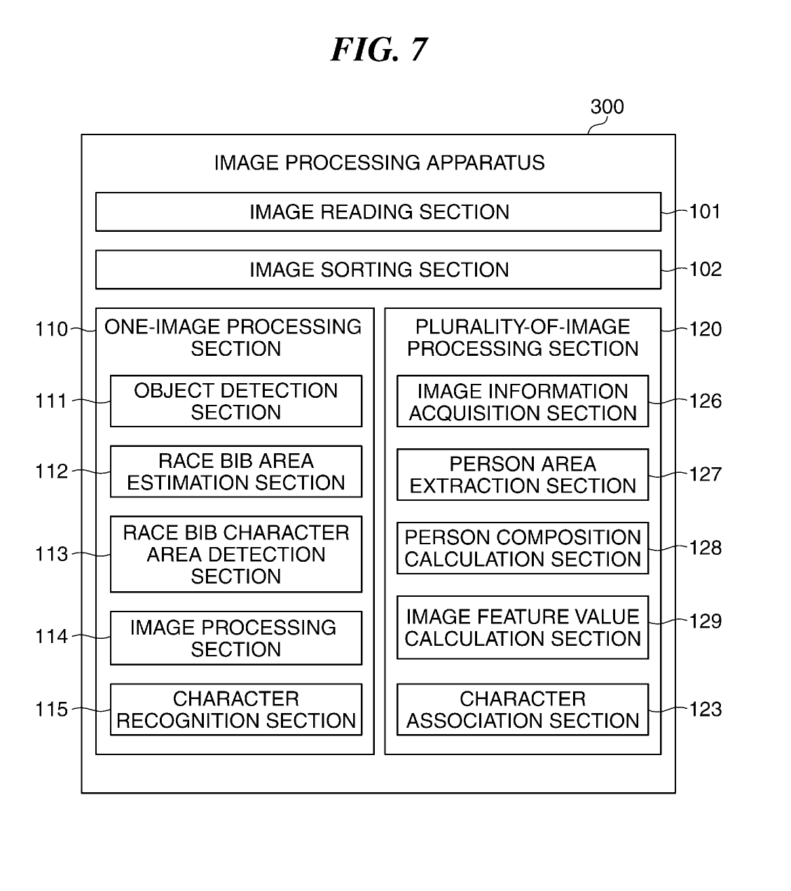

FIG. 7 is a block diagram of an example of an image processing apparatus 300 according to the third embodiment.

The present embodiment has the same configuration as that of the image processing apparatus 100 described in the first embodiment, in respect ranging from the image reading section 101 to the character recognition section 115. The present embodiment differs from the first embodiment in an image information acquisition section 126, a person area extraction section 127, a person composition calculation section 128, and an image feature value calculation section 129, of the plurality-of-image processing section 120. Note that the same component elements as those of the image processing apparatus 100 shown in FIG. 1 are denoted by the same reference numerals, and description thereof is omitted.

The image information acquisition section 126 acquires image information, such as vertical and lateral sizes, photographing conditions, and photographing position information, of an input image. Here, the photographing conditions refer to setting information of the camera, such as an aperture, zoom, and focus. Further, the photographing position information refers to position information estimated based on information obtained via a GPS equipped in the camera, or information obtained by a communication section of the camera e.g. by Wi-Fi or iBeacon.

The person area extraction section 127 extracts a person area including a person, from which a background image is excluded, from an input image. By extracting an area from which a background image is excluded, from an input image, it is possible to reduce the influence of the background image. Further, one or a plurality of persons may be included in the input image.

The person composition calculation section 128 calculates a composition feature value based on the photographing composition from a position of the person area with respect to the whole image.

The image feature value calculation section 129 calculates an image feature value based on a hue distribution of the image of the person area.

If the image size of a temporally sequential input image is substantially equal to that of a target image, and the image feature value calculated by the image feature value calculation section 129 is similar to that of the target image, the character association section 123 judges that these are the input images in which the same target person is photographed, and associates all of the characters associated with the reference image with the target image.

### <Processing Flow of Image Processing Apparatus 300>

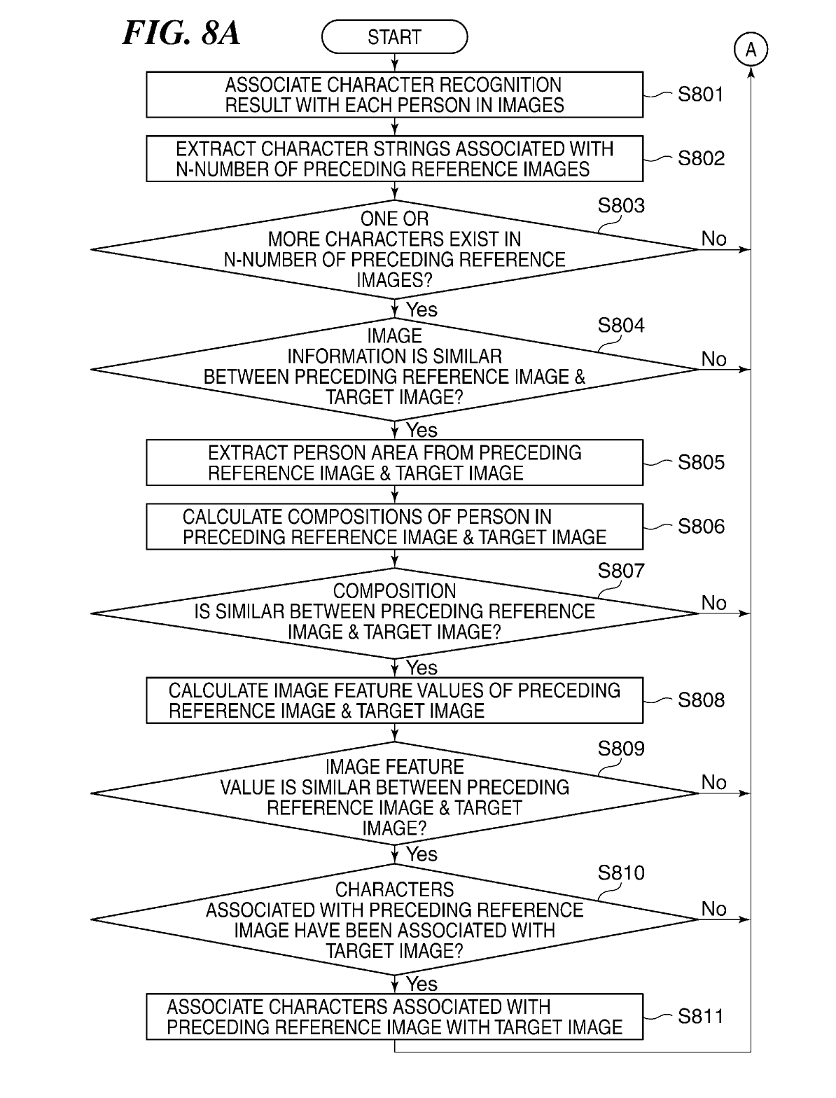

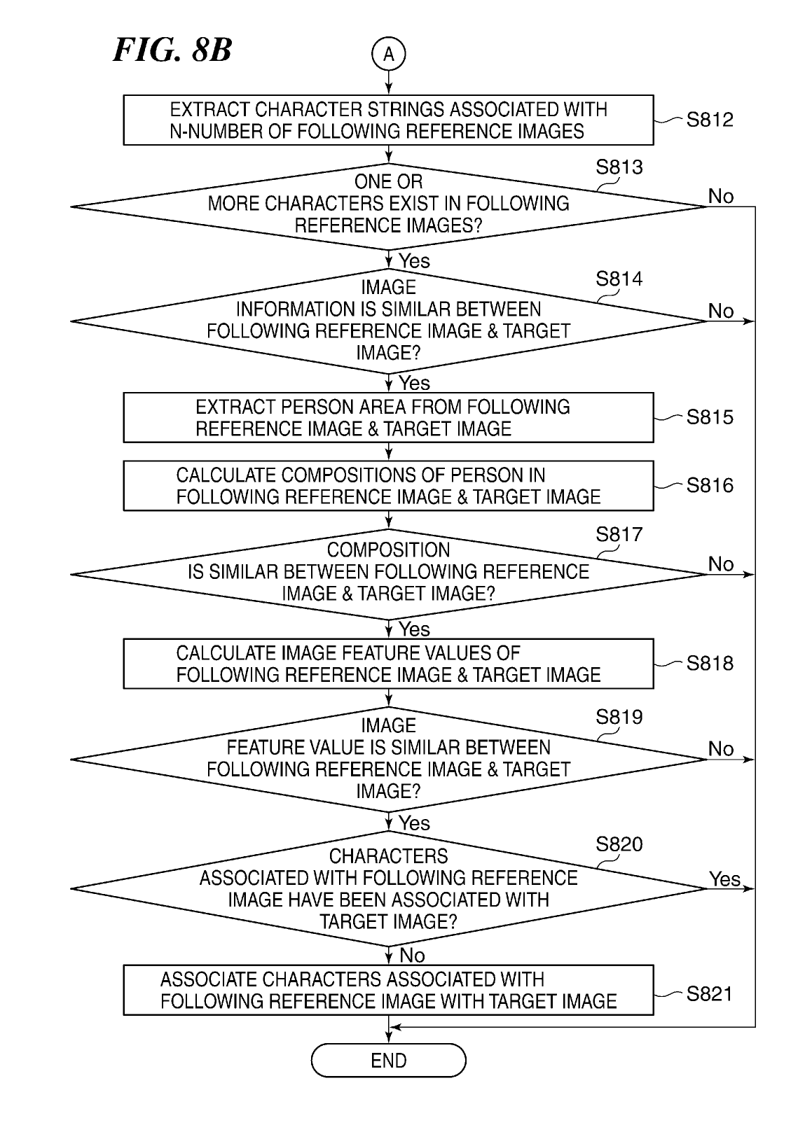

FIG. 8 is a flowchart useful in explaining a process performed by the image processing apparatus 300 shown in FIG. 7, for associating a race bib number and a person image with each other based on image information, composition feature values, and image feature values.

In the following description, an input image with which characters are to be associated is referred to as the target image, and a n-number of temporally sequential input images earlier than the target image are referred to as the preceding reference images. On the other hand, a n-number of temporally sequential input images later than the target image are referred to as the following reference images.

Here, the number n may be one or plural, and may be changed by taking into account a difference in photographing time between the input images.

The whole process performed for photographed images is the same as the steps S201 to S203 described with reference to FIG. 2A in the first embodiment. Details of the step S202 in the present embodiment, which is executed by the one-image processing section 110 and the plurality-of-image processing section 120 with respect to (2n+1) images read as input images, sequentially or in parallel, will be described with reference to FIG. 8.

A step S801 corresponds to the steps S211 to S218 in FIG. 2B, described in the first embodiment, wherein persons in the input images are detected, and a result of character recognition is associated therewith.

The character recognition section 115 extracts character strings associated with the n-number of preceding reference images (step S802).

The character recognition section 115 determines whether or not there are one or more characters associated with any person in the n-number of preceding reference images (step S803). If there are one or more characters associated with any person in the preceding reference images (Yes to the step S803), the process proceeds to a step S804. If there are no characters associated with any person in the n-number of preceding reference images (No to the step S803), the process proceeds to a step S812.

The image information acquisition section 126 acquires the vertical and lateral sizes, photographing conditions, and photographing position information, of the image including the characters associated with the target image, and determines whether or not the image information is similar between the target image and the preceding reference image (step S804). If the image information is similar (matches or approximately equal) (Yes to the step S804), the process proceeds to a step S805. If the image information is different (No to the step S804), it is assumed that the photographing target is changed, and hence the process proceeds to the step S812.

The person area extraction section 127 extracts a person area from which the background image is excluded, based on the person areas detected from the preceding reference images and the target image by the object detection section 111 (step S805).

The person composition calculation section 128 calculates a composition feature value based on the composition of a person, depending on where the person area is positioned with respect to the whole image of each of the target image and the preceding reference images (step S806). Here, the composition refers e.g. to a center composition in which a person is positioned in the center of the image or its vicinity, a rule-of-thirds composition in which the whole person is positioned at a grid line of thirds of the image, and so forth. The composition feature value is obtained by converting the features of composition into a value according to a degree of the composition.

The person composition calculation section 128 compares the composition feature value between the preceding reference image and the target image (step S807). If the composition feature value is equal between the preceding reference image and the target image (Yes to the step S807), the process proceeds to a step S808. If the composition feature value is different (No to the step S807), the process proceeds to the step S812.

The image feature value calculation section 129 calculates an image feature value based on hue distributions of the target image and the preceding reference image (step S808). Here, the hue for calculating the hue distribution may be detected not from the whole image, but from only an area including a person, from which the background part is deleted. Further, as the image feature value, not only a hue distribution, but also a brightness distribution may be considered. In addition, the image feature value may be calculated based on a feature value of each of small areas into which an input image is divided, and a positional relationship between the areas.

The image feature value calculation section 129 compares the image feature value of the target image and the image feature value of the preceding reference image (step S809).

If the image feature value is similar between the target image and the preceding reference image (Yes to the step S809), it is determined whether or not there are characters already associated with the target image (step S810). If the image feature value is not similar (No to the step S809), the process proceeds to the step S812.

If there are characters which are associated with the preceding reference image, but not associated with the target image (No to the step S810), the character association section 123 associates the characters associated with the preceding reference image with the target image (step S811). If there are no characters which are not associated with the target image (Yes to the step S810), the process proceeds to the step S812.

In the steps S812 to 821, the same processing as the steps 801 to S811 performed with respect to the preceding reference images is performed with respect to the following reference images.

The character recognition section 115 extracts character strings associated with the following reference images (step S812).

The character recognition section 115 determines whether or not there are one or more characters associated with any person in the following reference images (step S813). If there are one or more characters associated with any person in the following reference images (Yes to the step S813), the process proceeds to the step S814. If there are no characters associated with any person in the following reference images (No to the step S813), the processing flow is terminated.

The image information acquisition section 126 acquires the vertical and lateral sizes, photographing conditions, and photographing position information, of the image including the characters associated with the target image, and determines whether or not the image information is approximately equal between the target image and the following reference image (step S814). If the image information is approximately equal (Yes to the step S814), the process proceeds to the step S815. If the image information is largely different (No to the step S814), it is regarded that the photographing target is changed, and hence the processing flow is terminated.

The person area extraction section 127 extracts a person area, from which the background image is excluded, based on the person areas detected from the following reference images and the target image by the object detection section 111 (step S815).

The person composition calculation section 128 calculates a composition feature value based on the composition of a person, depending on where the person area is positioned with respect to the whole image of each of the target image and the following reference image (step S816).

The person composition calculation section 128 compares the composition feature value between the following reference image and the target image (step S817). If the composition feature value is equal between the following reference image and the target image (Yes to the step S817), the process proceeds to the step S818. If the composition feature value is different (No to the step S817), the processing flow is terminated.

The image feature value calculation section 129 calculates an image feature value based on hue distributions of the target image and the following reference image (step S818).

The image feature value calculation section 129 compares the image feature value of the target image and the image feature value of the following reference image (step S819).

If the image feature value is similar between the target image and the following reference image (Yes to the step S819), it is determined whether or not there are characters already associated with the target image (step S820). If the image feature value is not similar (No to the step S819), the processing flow is terminated.

If there are characters which are associated with the preceding reference image, but not associated with the target image (No to the step S820), the character association section 123 associates the characters associated with the following reference image with the target image (step S821). If there are no characters which are not associated with the target image (Yes to the step S820), the processing flow is terminated.

However, when searching for the characters associated with the target image A in the step S820, the characters are checked including the characters which have already been associated with the target image based on the characters associated with the preceding reference image, in the step S811, and the same characters are excluded so as not to be associated with the target image.

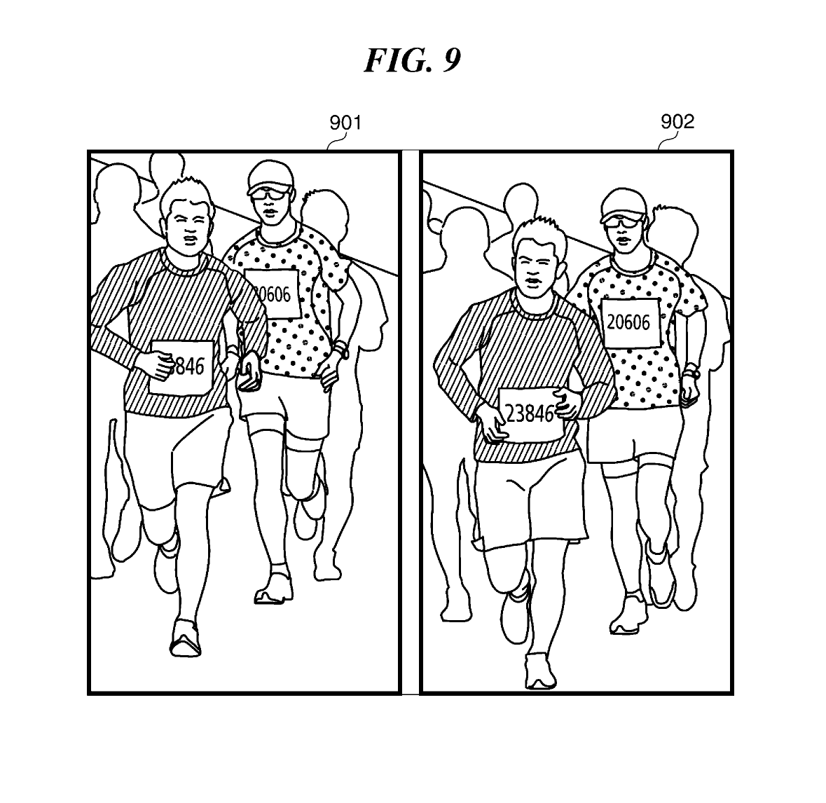

FIG. 9 shows an example of input images, and the process performed by the image processing apparatus 300, for associating a race bib number and a person image with each other based on image information and feature values of input images, will be described with reference to FIG. 9.

An image 901 and an image 902 are temporally sequential input images sorted by the image sorting section 102. The steps of the processing flow described with reference to FIGS. 8A and 8B will be described using these images 901 and 902. Here, it is assumed that the image 902 is a target image, and the image 901 is a preceding reference image. It is assumed that the steps S801 and 802 have already been executed, and the characters of the image 901 are not associated with the image 902 yet. Further, the description is given of an example in which there are only preceding reference images, and the steps S812 to S821 executed with respect to the following reference images are omitted.

In the step S803, the character recognition section 115 determines that there are one or more characters associated with persons in the image 901.

In the step S804, the image information acquisition section 126 acquires the vertical and lateral sizes, photographing conditions, and photographing position information, of the input images of the image 901 and the image 902, and determines that the image information is approximately equal.

In the step S805, the person area extraction section 127 cuts out person areas, from which background images are excluded, from the image 901 and the image 902.

In the step S806, the person composition calculation section 128 calculates composition feature values of the image 901 and the image 902.

In the step S807, the person composition calculation section 128 compares the composition feature value between the image 901 and the image 902, and determines that the composition feature value is equal between them.

In the step S808, the image feature value calculation section 129 calculates hue distributions of the image 901 and the image 902, as image feature values.

In the step S809, the image feature value calculation section 129 compares the image feature value between the image 901 and the image 902, and determines that the image feature value is similar.

Here, the similarity determination on the image feature values is performed e.g. by calculating an image feature value at each extracted point in the hue distribution, standardizing the maximum value of the image feature value to 100, and determining based on an amount of difference at each extracted point.

In the step S810, the character association section 123 determines that the characters of the image 901 are not associated with the image 902.

In the step S811, the character association section 123 associates the characters associated with the image 901 with the image 902.

As described above, according to the third embodiment of the present invention, in a case where it is impossible to correctly recognize a race bib in an input image, it is possible to associate a character string of another input image with the race bib in the input image, by extracting a person areas, from which the background image is excluded, from the input image, and using the composition feature values and the image feature value of the other input image which is temporally sequential to the input image.

### Fourth Embodiment

### <Configuration of Image Processing Apparatus 400>

Next, a description will be given of a fourth embodiment of the present invention.

The first to third embodiments use the method of calculating a feature value in an input image (a face feature value, a relative position, a composition feature value, and an image feature value), and associating characters of another input image with the input image. The fourth embodiment uses a method of associating characters with a target image, by using temporal continuity of input images without referring to an image within the input image. The fourth embodiment does not involve image processing, and hence it is possible to perform high-speed processing.

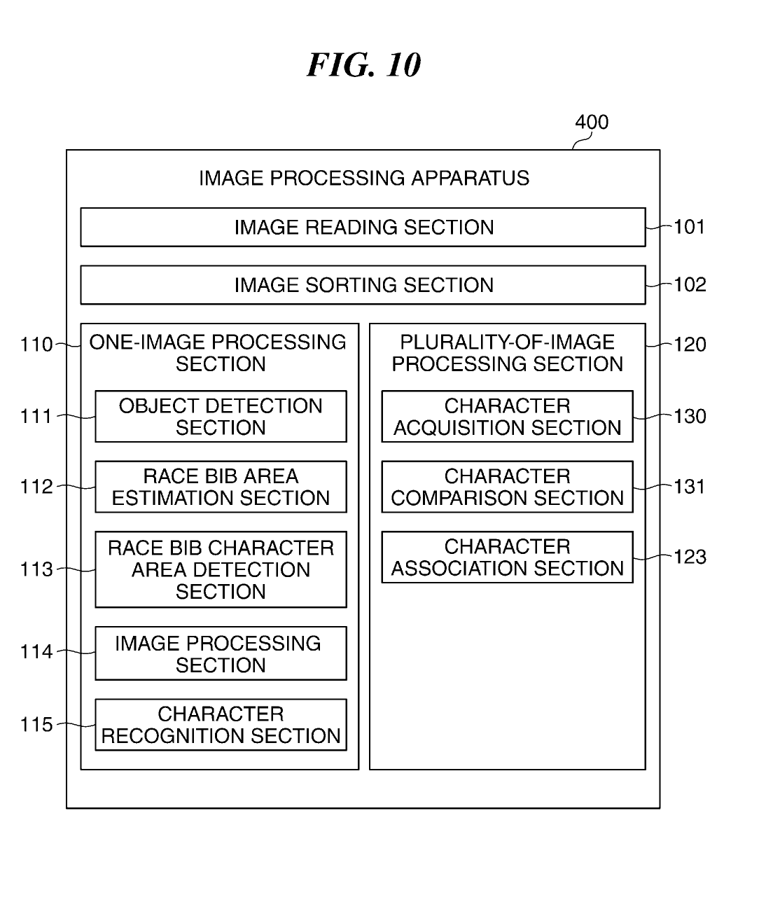

FIG. 10 is a block diagram of an example of an image processing apparatus 400 according to the fourth embodiment.

The present embodiment has the same configuration as that of the image processing apparatus 100 described in the first embodiment, in respect of the image reading section 101 and the image sorting section 102. The present embodiment differs from the first embodiment in a character acquisition section 130 and a character comparison section 131.

The character acquisition section 130 extracts, from a plurality of input images, characters associated with the images.

The character comparison section 131 compares a plurality of characters extracted by the character acquisition section 130.

As a result of comparison by the character comparison section 131, if the same characters exist before and after the target image, and the characters are not associated with the target image, the character association section 123 associates the characters with the target image.

### <Processing Flow of Image Processing Apparatus 400>

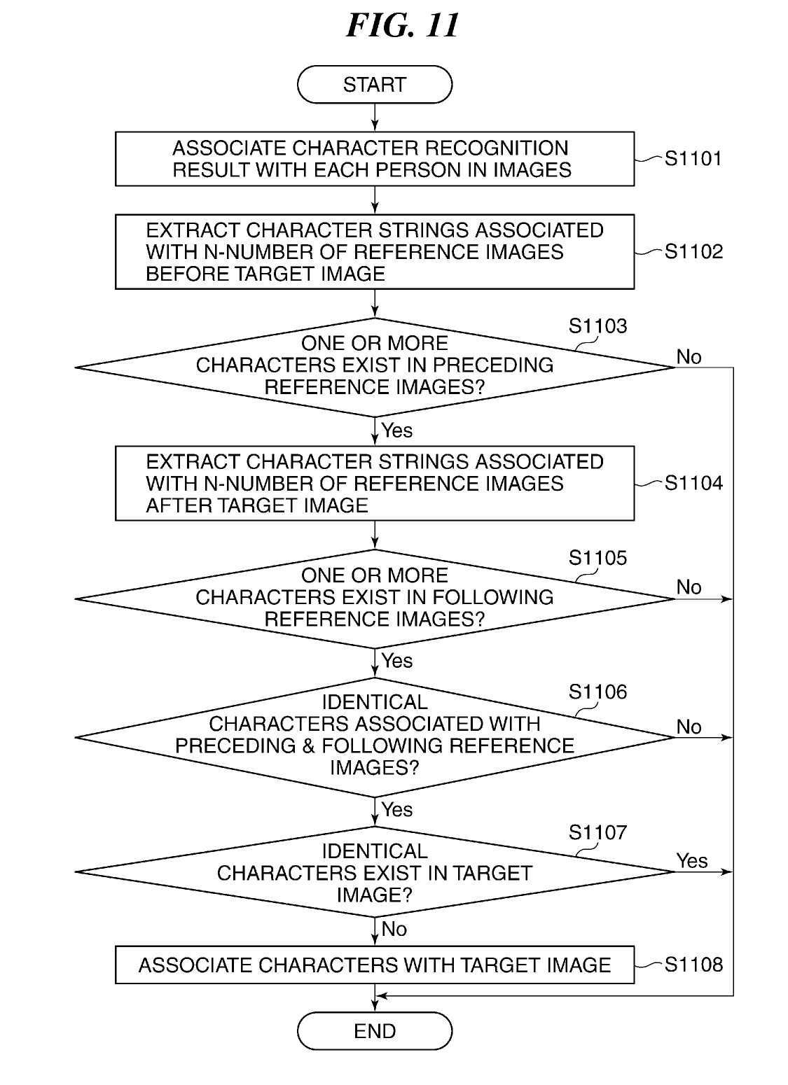

FIG. 11 is a flowchart useful in explaining a process performed by the image processing apparatus 400 shown in FIG. 10, for associating a race bib number and a person image with each other based on information of a race bib number of preceding and following images.

In the following description, an input image with which characters are to be associated is referred to as the target image, and a n-number of temporally sequential input images earlier than the target image are referred to as the preceding reference images. On the other hand, a n-number of temporally sequential input images later than the target image are referred to as the following reference images.

The whole process performed for photographed images is the same as the steps S201 to S203 described with reference to FIG. 2A in the first embodiment. Details of the step S202 in the present embodiment, which is executed by the one-image processing section 110 and the plurality-of-image processing section 120 with respect to (2n+1) images read as input images, sequentially or in parallel, will be described with reference to FIG. 11.

A step S1101 corresponds to the steps S211 to S218 in FIG. 2B, described in the first embodiment, wherein persons in the input images are detected, and a result of character recognition is associated with each detected person.

The character acquisition section 130 extracts character strings associated with the reference images before the target image (step S1102).

Next, the character acquisition section 130 determines whether or not there are one or more characters as a result of extraction in the step S1102 (step S1103).

If there are no characters in the preceding reference images (No to the step S1103), the processing flow is terminated.

If there are one or more characters in the preceding reference images (Yes to the step S1103), the process proceeds to a next step S1104.

The character acquisition section 130 extracts character strings associated with the reference images after the target image (step S1104).

Next, the character acquisition section 130 determines whether or not there are one or more characters as the result of extraction in the step S1104 (step S1105).

If there are no characters in the following reference images (No to the step S1105), the processing flow is terminated.

If there are one or more characters in the following reference images (Yes to the step S1105), the process proceeds to a next step S1106.

Characters which are identical between the reference images before the target image and the reference images after the target image are searched for (step S1106). If there are no identical characters (No to the step S1106), the processing flow is terminated. If there are identical characters (Yes to the step S1106), the process proceeds to a step S1107.

The character comparison section 131 searches the target image for the identical characters (step S1107).

If there are the identical characters in the target image (Yes to the step S1107), the processing flow is terminated.

If there are not the identical characters in the target image (No to the step S1107), the character association section 123 associates the identical characters in the preceding and following reference images with the target image (step S1108).

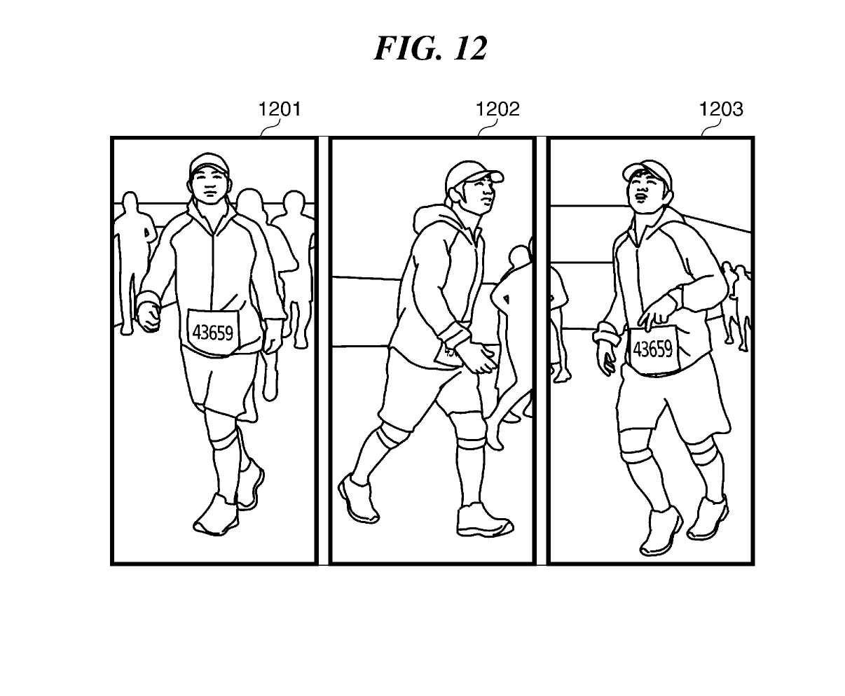

FIG. 12 shows an example of input images, and the process performed by the image processing apparatus 400, for associating a race bib number and a person image with each other based on information of a race bib number of preceding and following input images will be described with reference to FIG. 12.

Images 1201 to 1203 are temporally sequential input images sorted by the image sorting section 102. The steps of the processing flow described with reference to FIG. 11 will be described using these images 1201 to 1203. Here, it is assumed that the image 1202 is a target image, the image 1201 is a preceding reference image, and the image 1203 is a following reference image. Further, it is assumed that the step S1101 has already been executed with respect to the images 1201 to 1203.

In the steps S1102 and S1103, the character acquisition section 130 extracts a character string from the image 1201, and acquires “43659” as a race bib number.

Similarly, in the steps S1104 and S1105, the character acquisition section 130 extracts a character string from the image 1203, and acquires “43659” as a race bib number.

In the step S1106, it is determined that the character string acquired from the image 1201 and the character string acquired from the image 1203 are identical to each other.

In the step S1107, it is determined that the race bib of the person is hidden in the image 1201, and the characters cannot be recognized.

In the step S1108, in a case where the recognized characters are identical between the image 1201 as the preceding reference image and the image 1203 as the following reference image, the identical characters are associated with the image 1202.

As described above, according to the fourth embodiment of the present invention, in a case where it is impossible to correctly recognize a race bib in an input image, it is possible to associate, based on the identity of characters in temporally sequential preceding and following input images, a character string in the other input images.

Although present invention has been described heretofore based on the embodiments, the present invention is not limited to the above-described embodiments, but it can be practiced in various forms, without departing from the spirit and scope thereof.

When putting the present invention into practice, any of the first to fourth embodiments may be used, or any combination of the plurality of embodiments may be used. Further, when combining the plurality of embodiments, the order of combination of the embodiments may be changed such that the accuracy is made still higher, based on information of density of persons in the input images and so forth.

Note that the third embodiment shows an example in which in a case where the same characters have already been associated in the preceding reference image, the same characters associated with the following reference image are excluded so as not to be associated with the target image. Similarly, the exclusion may be similarly performed in the first, second, and fourth embodiments.

As described above, according to the first to fourth embodiments, in the system for associating characters of a race bib with a picture of an event participant, even when it is impossible to correctly recognize the characters on the race bib from an input image, characters associated with another input image are associated with the input image at high speed, whereby it is possible to reduce a time delay from photographing of pictures to putting the same on public view to thereby increase willingness to purchase, so that an increase in purchase rate in the image ordering system can be expected.

Although in the present embodiments, an object is described as a person, the object is not limited to a person, but may be an animal, a vehicle, or the like. Further, although in the description given above, the result of character recognition is associated with a person image within the photographed image, it may be associated with the photographed image itself.

Further, it is to be understood that the present invention may also be accomplished by supplying a system or an apparatus with a storage medium in which is stored a program code of software, which realizes the functions of the above described embodiments, and causing a computer (or a CPU, an MPU or the like) of the system or apparatus to read out and execute the program code stored in the storage medium.

In this case, the program code itself read out from the storage medium realizes the functions of the above-described embodiments, and the computer-readable storage medium storing the program code forms the present invention.

Further, an OS (operating system) or the like operating on a computer performs part or all of actual processes based on commands from the program code, and the functions of the above-described embodiments may be realized by these processes.

Further, after the program code read out from the storage medium is written into a memory provided in a function expansion board inserted in the computer or a function expansion unit connected to the computer, a CPU or the like provided in the function expansion board or the function expansion unit executes part or all of the actual processes based on commands from the program code, and the above-described embodiments may be realized according to the processes.

To supply the program code, a recording medium, such as a floppy (registered trademark) disk, a hard disk, a magneto-optical disk, an optical disk typified by a CD or a DVD, a magnetic tape, a nonvolatile memory card, and a ROM, can be used. Further, the program code may be downloaded via a network.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the priority of Japanese Patent Application No. 2015-075185 filed Apr. 1, 2015, which is hereby incorporated by reference herein in its entirety.

### REFERENCE SIGNS LIST

100, 200, 300, 400 image processing apparatus
101 image reading section
102 image sorting section
110 one-image processing section
111 object detection section
112 race bib area estimation section
113 race bib character area detection section
114 image processing section
115 character recognition section
120 plurality-of-image processing section
121 face feature value calculation section
122 similarity calculation section
123 character association section
124 person position detection section
125 relative position amount calculation section
126 image information acquisition section
127 person area extraction section
128 person composition calculation section
129 image feature value calculation section
130 character acquisition section
131 character comparison section

1. An image processing apparatus that repeatedly processes a plurality of input images as a target image, sequentially or in parallel, comprising:
an image sorting section that determines a processing order of the plurality of input images based on photographing environment information;
an identification information recognition section that performs recognition processing of identification information for identifying an object existing in the target image according to the processing order determined by the image sorting section, and associates a result of the recognition processing and the target image with each other;
a chronologically-ordered image comparison section that compares, in a case where an object which is not associated with the identification information exists in the target image processed by the identification information recognition section, a degree of similarity between the target image and reference images which are sequentially positioned chronologically before or after the target image in the processing order; and
an identification information association section that associates identification information associated with one of the reference images with the target image based on a result of comparison by the chronologically-ordered image comparison section.

2. The image processing apparatus according to claim 1, further comprising a face feature value calculation section that calculates a face feature value based on positions of organs of a face of the object, such as eyes and a mouth, and
wherein the chronologically-ordered image comparison section performs comparison based on the face feature value calculated by the face feature value calculation section.

3. The image processing apparatus according to claim 1, further comprising a relative position amount calculation section that calculates a relative position amount based on positions of a reference object and the object in the input image, and
wherein the chronologically-ordered image comparison section performs comparison based on the relative position amount calculated by the relative position amount calculation section.

4. The image processing apparatus according to claim 1, further comprising:
an image information acquisition section that acquires one or a plurality out of a size, a photographing condition, or photographing position information, of the input image;
an object extraction section that extracts an object area in which a background part is excluded from the input image;
a composition feature value calculation section that calculates a composition feature value based on a composition of the object area; and
an image feature value calculation section that calculates an image feature value based on a hue distribution of the object area, and
wherein the chronologically-ordered image comparison section performs comparison based on image information acquired by the image information acquisition section, the composition feature value calculated by the composition feature value calculation section, or the image feature value calculated by the image feature value calculation section.

5. The image processing apparatus according to claim 1, further comprising an identification information acquisition section that acquires the identification information associated by the identification information recognition section, and
wherein the chronologically-ordered image comparison section performs comparison based on the identification information acquired by the identification information acquisition section.

6. The image processing apparatus according to claim 1, wherein in a case where the same identification information as that associated with the preceding reference image or the following reference image has already been associated with the target image, the identification information association section does not associate the identification information with the target image.

7. An image processing method for an image processing apparatus that repeatedly processes a plurality of input images as a target image, sequentially or in parallel, comprising:
an image sorting step of determining a processing order of the plurality of input images based on photographing environment information;
an identification information recognition step of performing recognition processing of identification information for identifying an object existing in the target image according to the processing order determined in the image sorting step, and associating a result of the recognition processing and the target image with each other;
a chronologically-ordered image comparison step of comparing, in a case where an object which is not associated with the identification information exists in the target image processed in the identification information recognition step, a degree of similarity between the target image and reference images which are sequentially positioned chronologically before or after the target image in the processing order; and
an identification information association step of associating identification information associated with one of the reference images with the target image based on the result of comparison in the chronologically-ordered image comparison step.

8. The image processing method according to claim 7, further comprising a face feature value calculation step of calculating a face feature value based on positions of organs of a face of the object, such as eyes and a mouth, and
wherein the chronologically-ordered image comparison step performs comparison based on the face feature value calculated in the face feature value calculation step.

9. The image processing method according to claim 7, further comprising a relative position amount calculation step of calculating a relative position amount based on positions of a reference object and the object in the input image, and
wherein the chronologically-ordered image comparison step performs comparison based on the relative position amount calculated in the relative position amount calculation step.

10. The image processing method according to claim 7, further comprising:
an image information acquisition step of acquiring one or a plurality, out of a size, a photographing condition, or photographing position information, of the input image;
an object extraction step of extracting an object area in which a background part is excluded from the input image;
a composition feature value calculation step of calculating a composition feature value based on a composition of the object area; and
an image feature value calculation step of calculating an image feature value based on a hue distribution of the object area, and
wherein the chronologically-ordered image comparison step performs comparison based on image information acquired in the image information acquisition step, the composition feature value calculated in the composition feature value calculation step, or the image feature value calculated in the image feature value calculation step.

11. The image processing method according to claim 7, further comprising an identification information acquisition step of acquiring the identification information associated in the identification information recognition step, and
wherein the chronologically-ordered image comparison step performs comparison based on the identification information acquired in the identification information acquisition step.

12. The image processing method according to claim 7, wherein in a case where the same identification information as that associated with the preceding reference image or the following reference image has already been associated with the target image, the identification information association step does not associate the identification information with the target image.

13. An image processing system including an image pickup apparatus that photographs an object and an image processing apparatus connected to the image pickup apparatus via wire or wireless,
wherein the image processing apparatus repeatedly processes a plurality of input images as a target image, sequentially or in parallel, and comprises:
an image sorting section that determines a processing order of the plurality of input images based on photographing environment information;
an identification information recognition section that performs recognition processing of identification information for identifying an object existing in the target image according to the processing order determined by the image sorting section, and associates a result of the recognition processing and the target image with each other;
a chronologically-ordered image comparison section that compares, in a case where an object which is not associated with the identification information exists in the target image processed by the identification information recognition section, a degree of similarity between the target image and reference images which are sequentially positioned chronologically before or after the target image in the processing order; and
an identification information association section that associates identification information associated with one of the reference images with the target image based on a result of comparison by the chronologically-ordered image comparison section.
